(19) United States
(12) Patent Application Publication
(10) Pub. No.: US 2013/0291957 A1
(43) Pub. Date: Nov. 7, 2013

(54) SNAP RING INSTALLATION AND REMOVAL TOOL

(71) Applicants: JianYing Di, Peoria, IL (US); FengJuan Zhao, Peoria, IL (US)

(72) Inventors: JianYing Di, Peoria, IL (US); FengJuan Zhao, Peoria, IL (US)

(73) Assignee: Caterpillar Inc., Peoria, IL (US)

(21) Appl. No.: 13/463,905

(22) Filed: May 4, 2012

(51) Int. Cl. F02M 63/00; B23P 11/00; B23P 19/08

(52) U.S. Cl. 137/315.01; 29/229; 29/525.01

(57) ABSTRACT

A tool is provided. The tool includes a handle, a base, and a plurality of members. The base is attached to the handle. The plurality of members is affixed to the base at one end. Each of the plurality of members is capable of movement in a substantially lateral direction. Further, the plurality of members is configured to change a diameter of a snap ring from a first diameter to a second diameter based on the movement.

### TECHNICAL FIELD

The present disclosure relates to a tool, and more particularly to the tool used to install and remove a snap ring.

### BACKGROUND

Retention rings are typically used as fasteners in order to hold components or assemblies in a housing or bore. For example, U.S. Pat. No. 4,701,990 relates to a self-securing ball-and-socket joint which has a ball head integrally formed on a rod, an outer structural part having a bore that pivotably receives the ball head and a radially elastic CIRCLIP brand retaining ring as well as a separate auxiliary assembly tool for the retaining ring. In the outer structural part beside the center of the ball head, there is a circumferential groove having a support face for the retaining ring. When the ball-and-socket joint is assembled, the retaining ring is first inserted into the circumferential groove. Then the auxiliary assembly tool is inserted into the bore. Upon further displacement of the auxiliary assembly tool, the retaining ring snaps home into a detent notch provided on the circumference of the auxiliary assembly tool. As a result, the retaining ring is prevented from falling out of the outer structural part.

However, the auxiliary assembly tool may not provide an efficient solution for the installation and removal of the retaining ring when limited access space is provided. The present disclosure is aimed at addressing the above mentioned shortcomings.

### SUMMARY OF THE DISCLOSURE

In one aspect of the present disclosure a tool is provided. The tool includes a handle, a base, and a plurality of members. The base is attached to the handle. The plurality of members is affixed to the base at one end. Each of the plurality of members is capable of movement in a substantially lateral direction. Further, the plurality of members is configured to change a diameter of a snap ring from a first diameter to a second diameter based on the movement.

In another aspect, a method for installing or removing a snap ring relative to an injector body is provided. The method arranges a snap ring having a first diameter in contact with a plurality of members of a tool. The method moves the plurality of members in a substantially lateral direction. The method then changes the first diameter of the snap ring to a second diameter based on the movement of the plurality of members. Subsequently, the method performs any one of an installation operation of the snap ring onto an injector body or a removal operation of the snap ring from the injector body based, at least in part, on the changed diameter of the snap ring.

Other features and aspects of this disclosure will be apparent from the following description and the accompanying drawings.

### BRIEF DESCRIPTION OF THE DRAWINGS

FIG. 1 is a diagrammatic view of an exemplary system, according to one embodiment of the present disclosure;

FIGS. 2 to 4 are diagrammatic views of different tools;

FIGS. 5 and 6 are diagrammatic views of different handles of the tools shown in FIGS. 2 and 4 respectively;

FIGS. 7 and 8 are diagrammatic views of different bases of the tools shown in FIGS. 2 and 4 respectively;

FIGS. 9 and 10 are diagrammatic views of different members of the tools shown in FIGS. 2 and 4 respectively;

FIG. 11 is a diagrammatic view of the snap ring in a free state which is mounted on the tool shown in FIG. 3;

FIG. 12 is a diagrammatic view of the snap ring in an expanded state which is mounted on the tool shown in FIG. 3;

FIGS. 13 to 15 are sectional views of the tools shown in FIGS. 2 to 4 respectively, including a plane AA, during a removal operation of the snap ring;

FIG. 16 is a cross-sectional view of the system along the plane AA shown in FIGS. 13 to 15;

FIG. 17 is a cross-sectional view of the system having the snap ring in the expanded state; and

FIG. 18 is a process for installing or removing the snap ring relative to the injector body.

### DETAILED DESCRIPTION

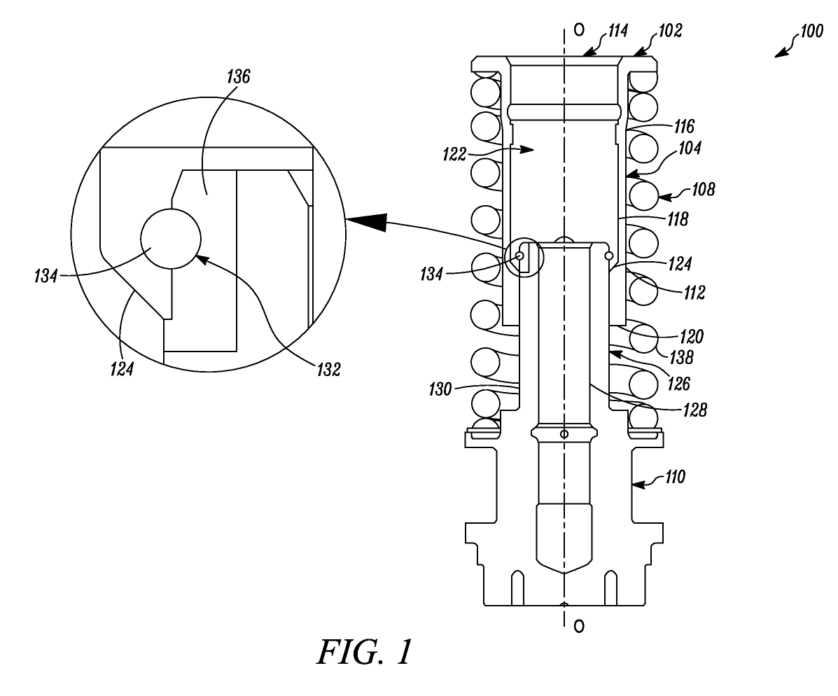

FIG. 1 illustrates an exemplary system 100 including an injector 102, according to one embodiment of the present disclosure. It may be apparent to one of ordinary skill in the art that the injector 102 may include a fuel injector to admit fuel into an engine of a work machine. As shown in FIG. 1, the injector 102 may include a tappet 104, a plunger (not shown in figure), a biasing means 108, and an injector body 110.

As shown in the accompanied figures, the tappet 104 may include a cylindrical body 112 extending from an opening 114 located at one end of the tappet 104. In one embodiment, a thrust plate (not shown in figure) may be fitted at the opening 114 of the tappet 104. Moreover, the thrust plate may be held in place using any retaining ring such as, for example, a seal-O-ring.

The cylindrical body 112 has an outer surface 116, an inner surface 118, and a bottom surface 120. The inner surface 118 defines a cylindrical tappet bore 122 having a first diameter. As shown in FIG. 1, the cylindrical body 112 and the tappet bore 122 may be centered about a longitudinal axis OO of the tappet 104. The inner surface 118 of the tappet 104 may include a chamfered edge 124.

In one embodiment, as depicted in FIG. 1, a lower portion of the tappet bore 122 may have a second diameter, such that the first diameter is greater than the second diameter. The injector body 110 may slidably engage within the lower portion of the tappet bore 122. The injector body 110 may define a barrel 126 having an inner surface 128 and an outer surface 130. Further, the inner surface 128 of the barrel 126 may define a bore therein, as shown in FIG. 1. The barrel 126 and the bore may be centered about the longitudinal axis OO. It should be understood that the first and second diameter of the tappet bore 122 is greater than a diameter of the outer surface 130 of the barrel 126 of the injector body 110.

Further, at least one groove 132 may be present on the injector body 110. In one embodiment, as shown in FIG. 1, the groove 132 may be located on a top portion of the injector body 110. The groove 132 may be circular in shape, such that the groove 132 is configured to house a retention ring (hereinafter interchangeably referred to as snap ring 134). Parameters related to the groove 132 including location, depth, and the like may vary without any limitation. In one embodiment, the injector body 110 may include a plurality of slots 136.

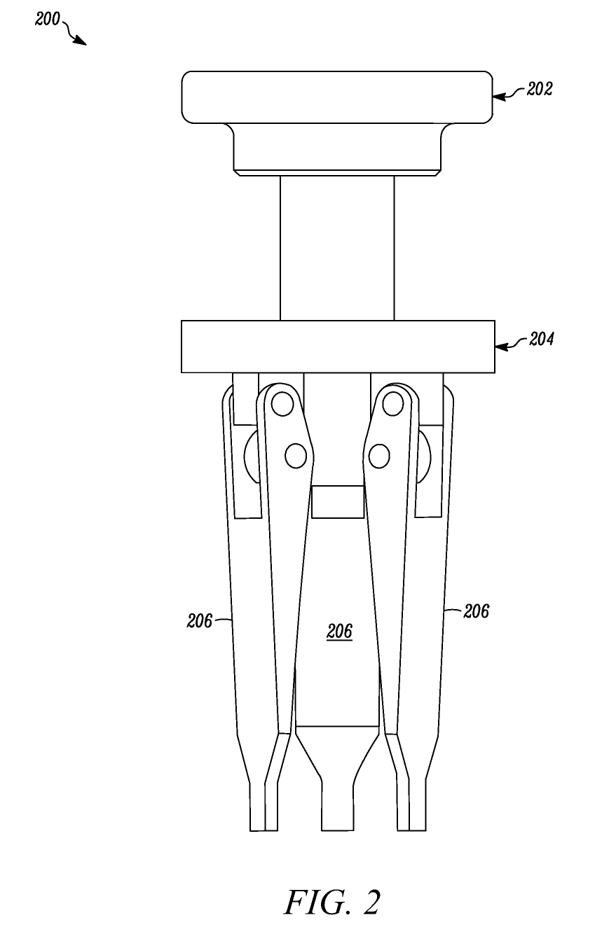

The present disclosure relates to different tools 200, as depicted in FIGS. 2 to 4, for performing either one of an installation operation of the snap ring 134 onto the injector body 110 or removal operation of the snap ring 134 from the injector body 110, which will be explained later. The tool 200 is inserted within the tappet bore 122 of the system 100 to perform the installation or removal operations.

In one embodiment, the snap ring 134 may have a circular shape, such that the snap ring 134 is not continuous and possesses a break anywhere in a circumference of the snap ring 134. The snap ring 134 may be made of metal. When not installed on the system 100, the snap ring 134 is free from any stress and may be said to be in a free state. The snap ring 134, when installed in the system 100, may be placed in contact with the groove 132 of the injector body 110 and the inner surface 118 and/or chamfered edge 124 of the tappet 104. At this instant, the snap ring 134 may be said to be in a normal working states.

The plunger may be partially located within the tappet bore 122 and a remaining part of the plunger may be present within the bore of the injector body 110 as shown. A diameter of the plunger may be less than a diameter of the inner surface 128 of the barrel 126 of the injector body 110 such that the plunger may be slidably disposed within the bore of the injector body 110. The plunger may be free-floating or attached to the tappet 104. Parameters related to the plunger such as the length, diameter, and the like may vary. It should be noted that a short length of the plunger may result in a short sealing length, giving rise to fuel in oil leakage issue. Hence, in one embodiment, a relatively longer length of the plunger may be utilized.

In one embodiment, as shown in the accompanied figures, the biasing means 108 may include a spring 138 of a compression-type configuration. The spring 138 may have an inner diameter being greater than or equal to the diameter of the outer surface 116 of the tappet 104. The spring 138 may have a top end and a bottom end. The bottom end may be in contact with the injector body 110, and the top end may be in contact with a top portion of the tappet 104. A person of ordinary skill in the art will appreciate that the any other biasing means 108 may be utilized, such as a plurality of Belleville washers, one or more elastomeric members, and the like. Additionally, the system 100 may include other components not described herein.

Referring to FIGS. 2 to 4, the tool 200 may include a handle 202, a base 204 and a plurality of members 206. The base 204 may be attached to the handle 202. The plurality of members 206 may be affixed to the base 204 at one end, and free at another end. Moreover, each of the plurality of members 206 may be capable of movement in a substantially lateral direction. The plurality of members 206 may be configured to change a diameter of the snap ring 134 from the first diameter to a second diameter, based on the movement of the plurality of members 206. It should be noted that although three members 206 are shown in the each of the tools 200 depicted in FIGS. 2 to 4, the number of members 206 may vary.

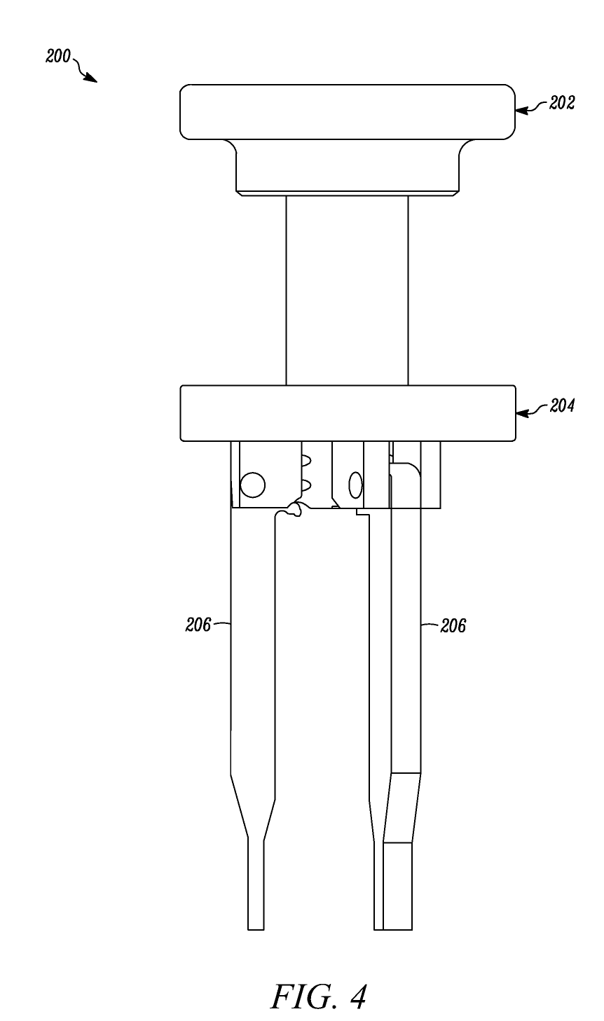

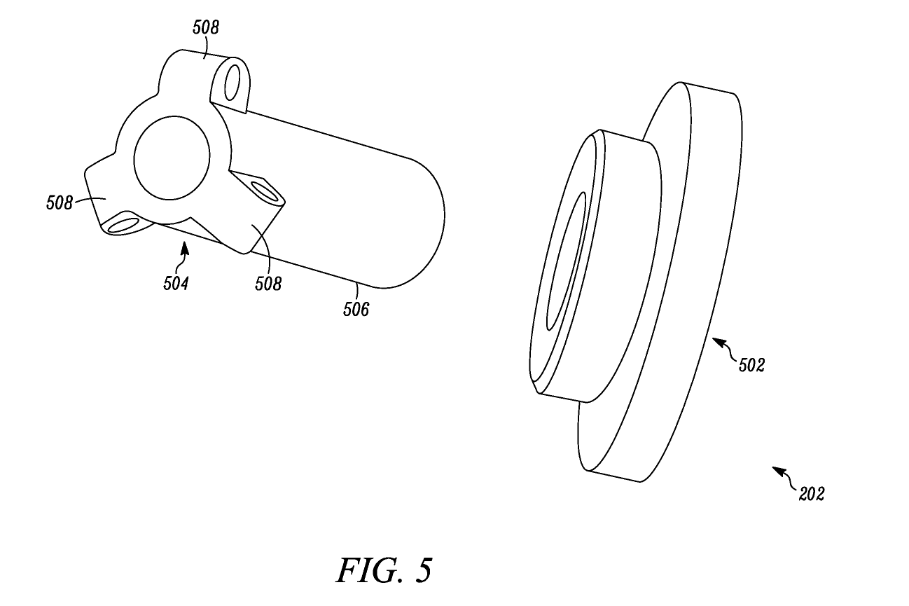

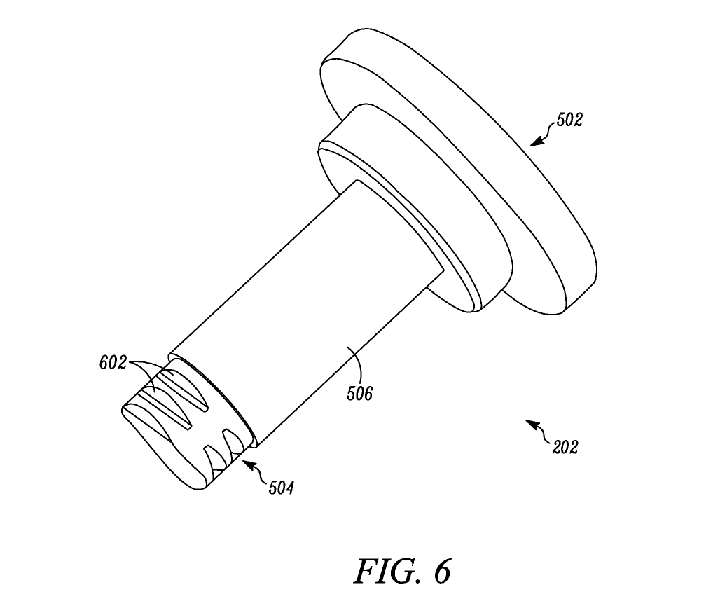

FIGS. 5 and 6 are exploded views of the handle 202 as shown in FIGS. 2 and 4 respectively. The handle 202 may include a top portion 502 and a bottom portion 504, linked by a cylindrical body 506. In one embodiment, as shown in FIG. 5, the top and bottom portion 502, 504 may be attached together using any suitable means. Alternatively, the top portion 502, the cylindrical body 506 and the bottom portion 504 may be integrated as shown in FIG. 6.

The top portion 502 of the handle 202 may be shaped to facilitate in easy grip by an operator. The cylindrical body 506 may be hollow or solid. As depicted in FIG. 5, the bottom portion 504 of the cylindrical body 506 may include a plurality of tubular structures 508 configured to receive a pin for coupling with the base 204 and/or each of the plurality of members 206. In one embodiment, the cylindrical body 506 may taper towards the bottom portion 504.

In another embodiment, as shown in FIG. 6, the bottom portion 504 of the handle 202 may include a plurality of grooves 602 configured to mate the handle 202 with corresponding projections or gear-like assembly structures present on the plurality of members 206. It should be understood that the shape of the bottom portion 504 may vary based on the type of connection between the handle 202 and the base 204, as well as the handle 202 and the plurality of members 206. In one embodiment, the handle 202 may be made of any polymer such as plastic. In another embodiment, a retention ring may be positioned at the bottom portion 504 of the handle 202. The dimensions and material used for making the handle 202 of the tool 200 may vary without any limitation.

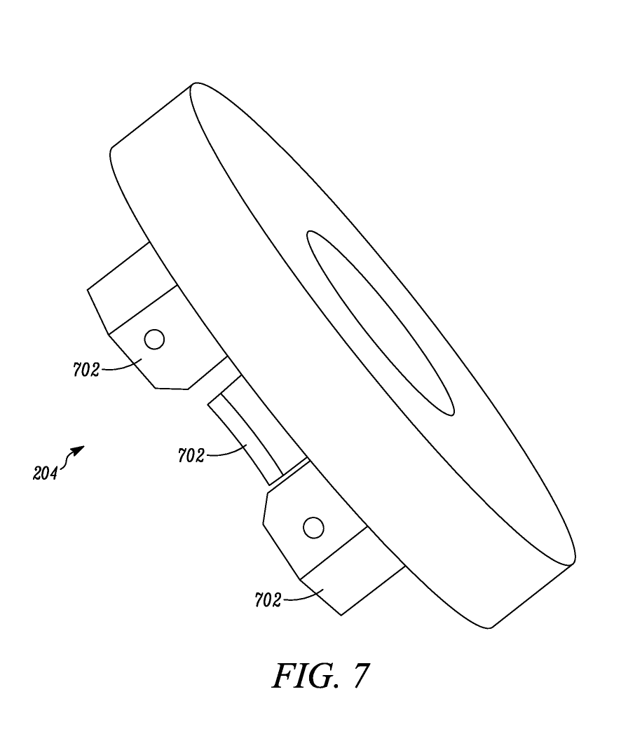

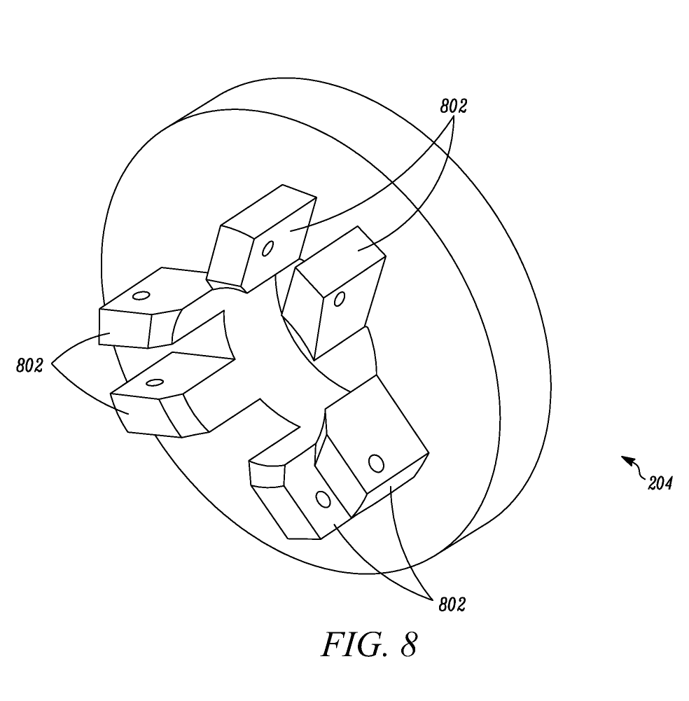

Exploded views of different designs of the base 204 are shown in FIGS. 7 and 8. As shown in the accompanied figures, the base 204 may be circular in shape, having an inner diameter and an outer diameter. The inner diameter of the base 204 may be greater than a diameter of the cylindrical body 506 of the handle 202, so that the cylindrical body 506 may be slidably disposed within the base 204. The handle 202 may be capable of substantially vertical movement relative to the base 204, depending on a force exerted by the operator. It should be noted that the outer diameter of the base 204 may be greater than the diameter of the tappet bore 122 to prevent the tool 200 from entering into the injector 102 during the installation or removal operation of the snap ring 134.

Moreover, as shown in FIG. 7, the base 204 may include a plurality of blocks 702 having holes configured to receive pins for coupling the base 204 with each of the plurality of members 204. Another design of the base is illustrated in FIG. 8 and is corresponding to the tool 200 shown in FIG. 4 wherein a pair of blocks 802 may be associated with each of the plurality of members 206. Hence, as shown in FIGS. 2 to 4, the plurality of members 206 may be attached to the base 204 and arranged in a circular arrangement.

In one embodiment, the base 204 may be made of a polymer such as plastic. However, it should be noted that any other substance may be used for making the base 204. It should be understood that other structural configurations of the base 204 providing slidable attachment with the handle 202 and fixed attachment with the plurality of members 206 not described herein may also be used.

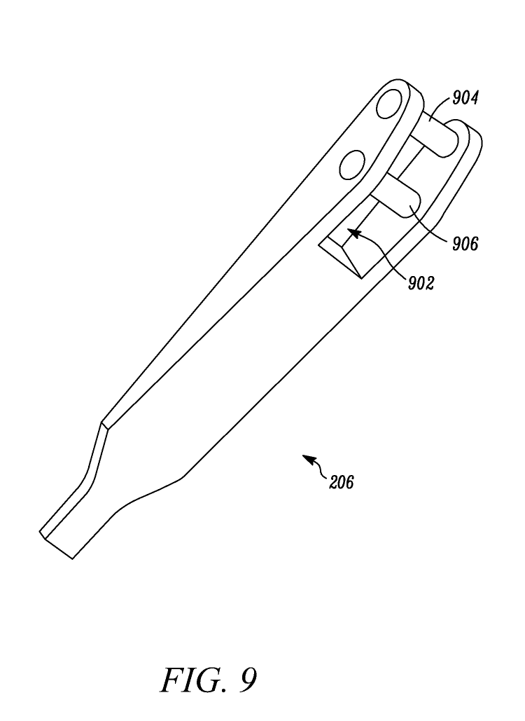

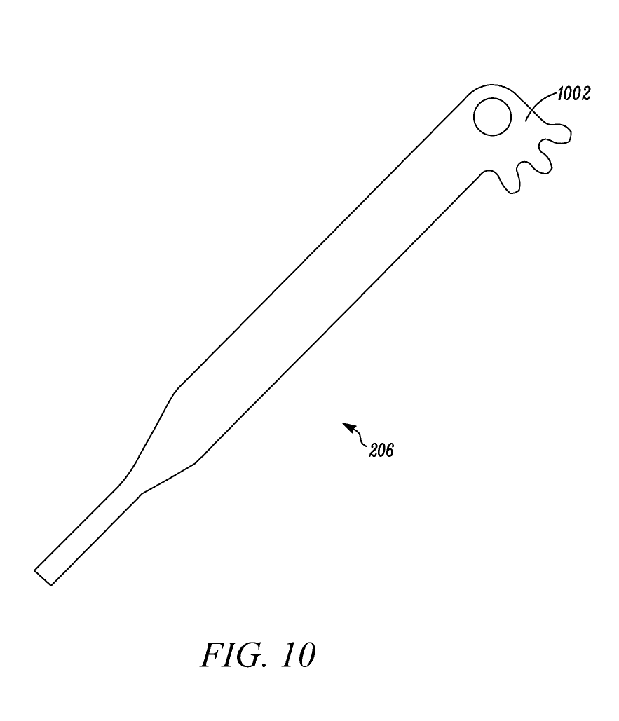

FIGS. 9 and 10 are exploded views of different members 206 that may be utilized in connection with the tools 200 shown in FIGS. 2 and 4 respectively. In one variation shown in FIG. 9, each of the plurality of members 206 may include a slot 902. The slot 902 may house an upper and lower pin 904, 906. In one embodiment, the lower pin 906 may facilitate in the connection of the member 206 with tubular structure 508 of the handle 202 (see FIGS. 2 and 5) and the upper pin 904 may facilitate in connection with the base 204. Moreover, it should be understood that the arrangements of the upper and lower pin 904, 906 is such so as to allow a pivotable connection about the upper pin 904 so that the vertical movement of the handle 202 may translate into the lateral movement of each of the plurality of members 206.

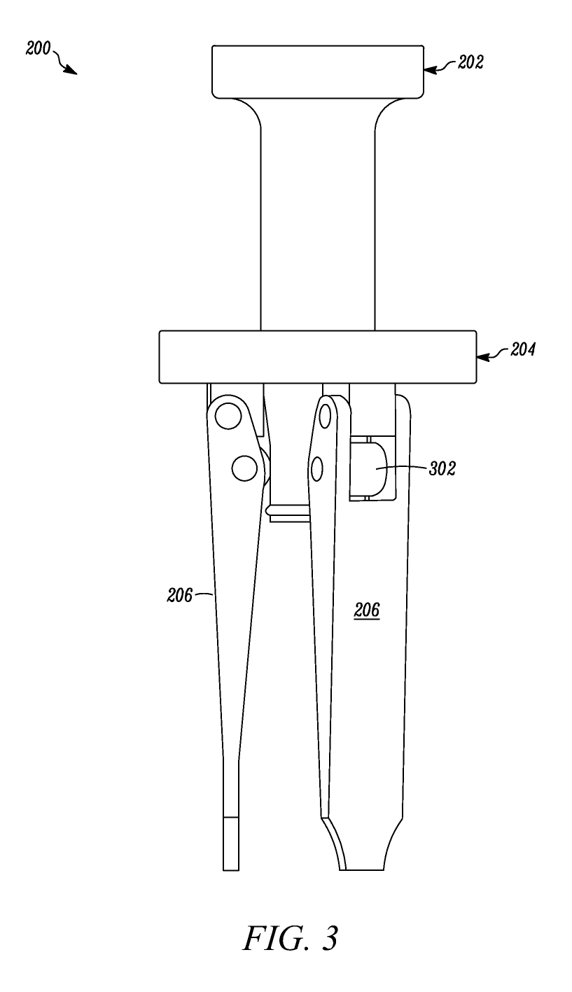

Alternatively, in one embodiment as shown in FIG. 3, a roller 302 may be fitted onto the lower pin 906 such that the roller 302 comes in contact with the tapered surface of the bottom portion 504 of the cylindrical body 506 of the handle 202, in order to translate the vertical movement of the handle 202 into the lateral movement of the members 206. It should be noted that the retention ring provided on the bottom portion 504 of the handle may prevent the roller 302 from losing contact with the handle 202 when the handle moves in the vertical direction.

In another embodiment, as shown in FIG. 10, a top portion of the each of the plurality of members 206 may have an integrated gear-like structure 1002 for mating with corresponding grooves 602 present on the bottom portion 504 of the handle 202 (see FIGS. 4 and 6). It may be observed that a lower portion of the member 206 may be relatively narrower in width as compared to an upper portion of the member 206 in order to facilitate in inserting the member 206 within the slot 136 provided on the injector body 110. In one embodiment, each of the plurality of members 206 may be made of metal. The length of each of the plurality of members 206 may be accordingly chosen in order to fit into the tappet bore 122 and facilitate in the installation or removal of the snap ring 134 relative to the injector body 110.

The tools 200 depicted in FIGS. 2 to 4 may facilitate in changing the diameter of the snap ring 134 from a first diameter to the second diameter. The first diameter of the snap ring 134 is the diameter of the snap ring 134 when the snap ring 134 may be in the free state or the normal working state. The second diameter of the snap ring 134 may be the diameter of the snap ring 134 when the snap ring 134 is in an expanded state. In one embodiment, the second diameter may be greater than the first diameter.

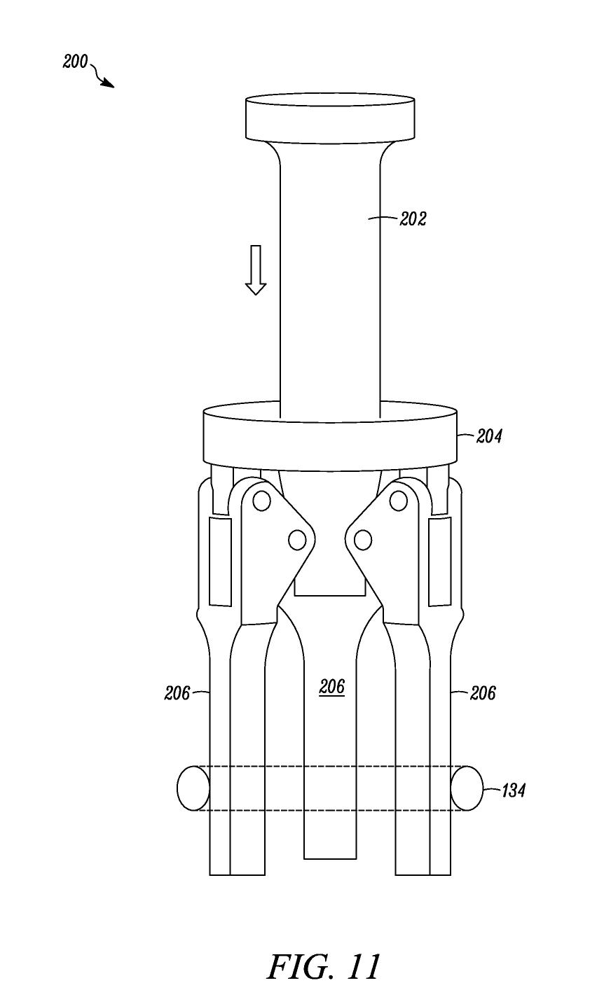

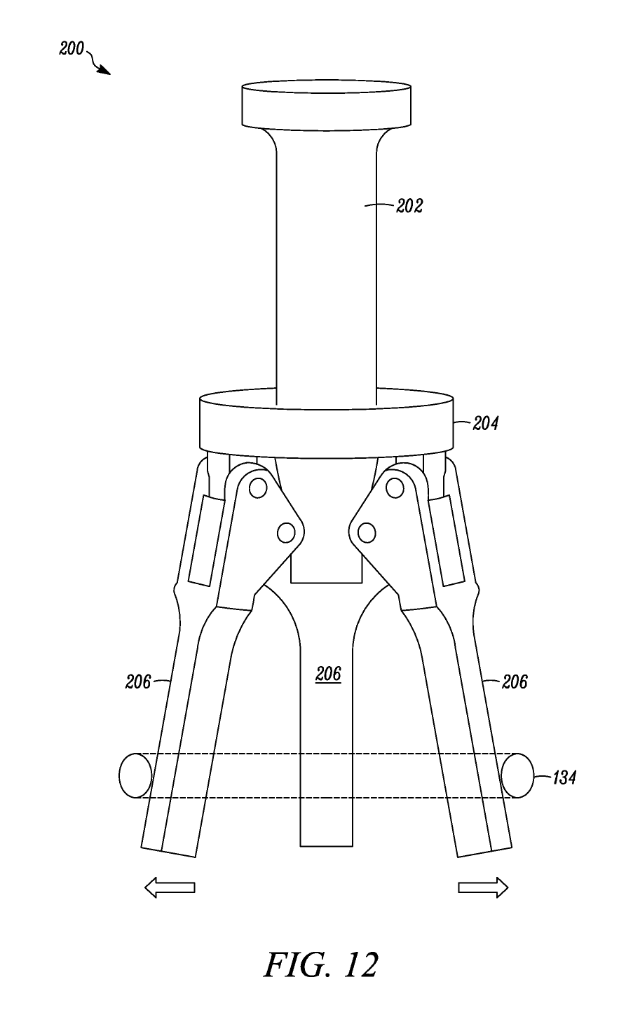

FIGS. 11 and 12 illustrate the change in state of the snap ring 134 from the free state to the expanded state. The snap ring 134 may be in the free state as shown in FIG. 11 and in contact with the plurality of members 206. The plurality of members 206 may also be in a free state such that each of the plurality of members 206 may be substantially vertical with respect to the base 204 of the tool 200. The arrowhead in the figure depicts the direction in which the handle 202 may be moved by the operator in order to expand the snap ring 134.

FIG. 12 illustrates the lateral movement of the movement of the plurality of members 206 as a result of the movement of the handle 202 in the downward direction. The arrowheads shown in the figure are indicative of the direction of movement of the plurality of members 206. Hence, in FIG. 12, the plurality of members 206 may be in the expanded state, wherein each of the plurality of members 206 is substantially inclined with respect to the base 204 of the tool 200.

It should be noted that the movement of the handle 202 in the downward direction may cause the plurality of members 206 to change from the free state to the expanded state. Moreover, on releasing the force on the handle 202 or on pulling the handle 202 in the upward direction, the positioning of the plurality of members 206 may change from the substantially inclined position to the substantially vertical position.

Moreover, the lateral movement of the plurality of members 206 may cause the change in the diameter of the snap ring 134 from the first diameter to the second diameter. The snap ring 134 shown in FIG. 12 may be in the expanded state. It should be noted that the change in the diameter of the snap ring 134 from the first diameter to the second diameter may facilitate in any one of the installation or removal operation of the snap ring 134 relative to the injector body 110.

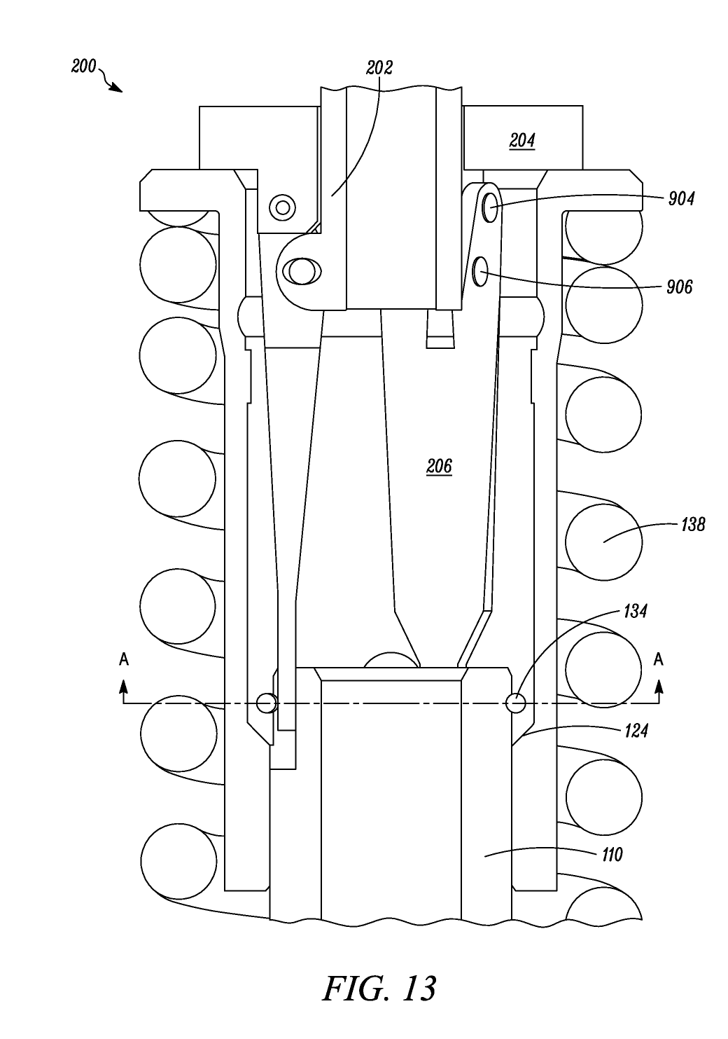

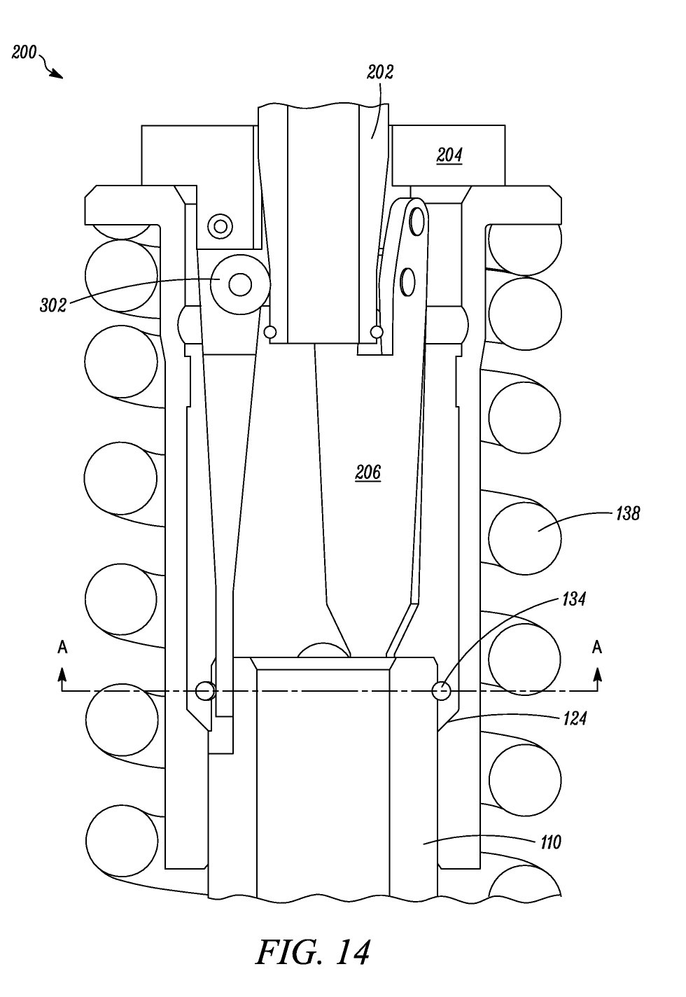

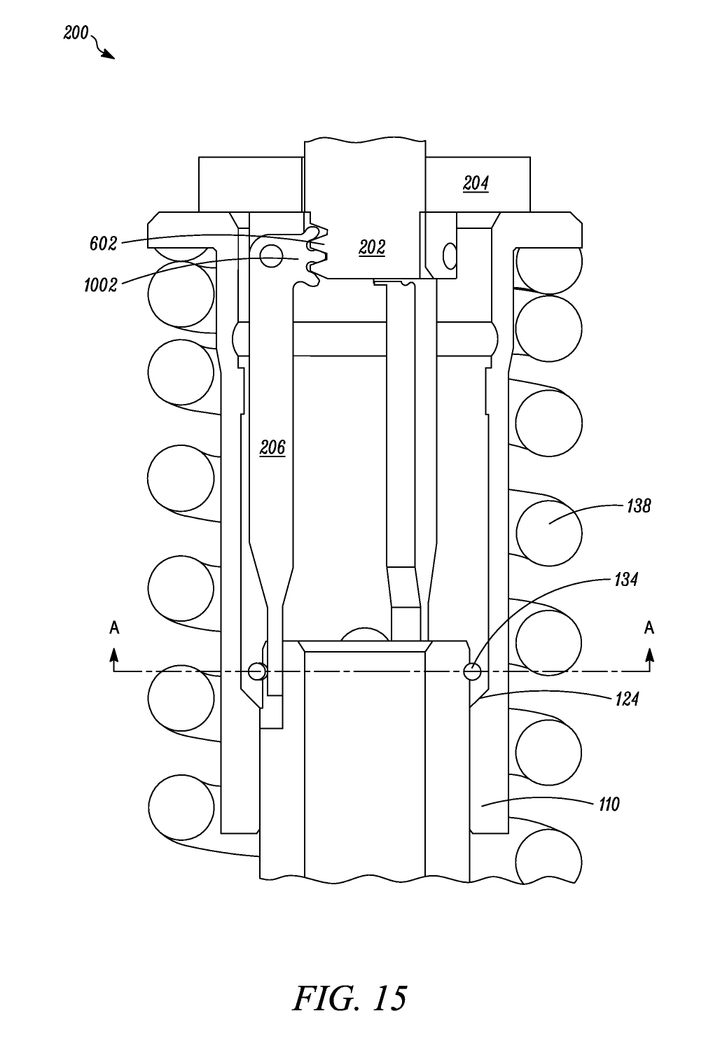

FIGS. 13 to 15 show sectional views of the different tools 200 depicted in FIGS. 2 to 4 respectively, when inserted within the tappet bore 122 of the system 100, during removal of the snap ring 134 from the injector body 110. FIGS. 13 to 15 also include a plane AA. As shown in the accompanied figures, an inner surface of each of the plurality of the members 206 may be engaged within the slots 136 provided on the injector body 110. During performance of the removal operation, initially the snap ring 134 is in the normal working state. As shown in the accompanied figures, when the plurality of members 206 are inserted into the slot 136 provided on the injector body 110, initially a relatively small gap or clearance exists between each of the plurality of members 206 and the snap ring 134. Moreover, a relatively larger space may exist between the inner surface 118 of the tappet 104 and the snap ring 134.

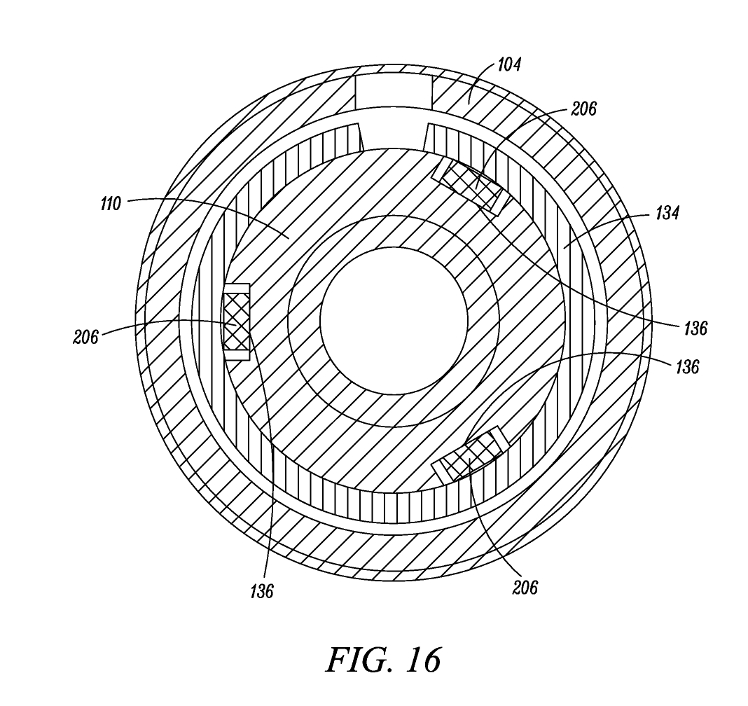

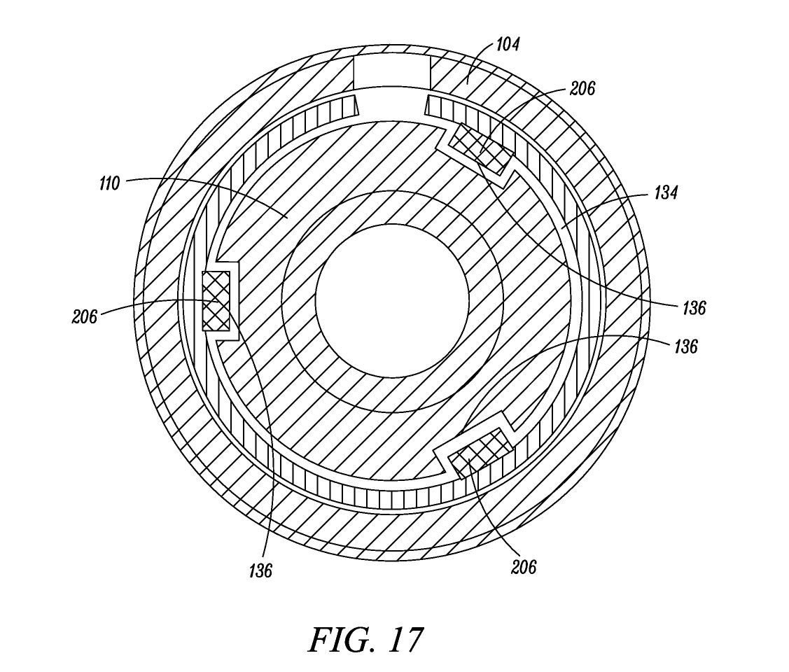

The cross-sectional view taken along the plane AA is illustrated in FIG. 16. In one embodiment, the snap ring 134 may be in the normal working state and the plurality of members 206 may be in the free state, as shown. Moreover, the plurality of members 206 may be in contact with the slot 136 provided on the injector body 110. FIG. 17 illustrates the cross-sectional view of the system 100 when the plurality of members 206 and the snap ring 134 may be in the expanded state. As is visible in the accompanied drawings, the space between the tappet 104 and the snap ring 134 may be relatively reduced and when the plurality of members 206 is in the expanded state. Moreover, a gap may be created between the slot 136 of the injector body 110 and the each of the plurality of members 206. It should be noted that the diameter of the snap ring 134, when in the expanded state, may be relatively larger than the diameter when in the free state or the normal working state.

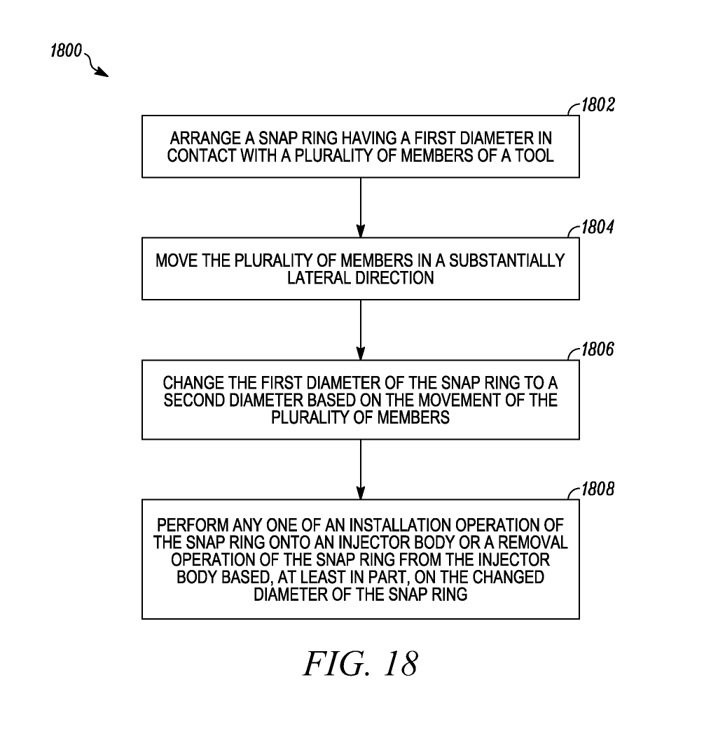

The installation and the removal operation of the snap ring 134 relative to the injector body 110 will be explained in detail in connection with FIG. 18. It should be noted that the different tools 200 depicted in FIGS. 2 to 4 illustrate different structural designs that may be utilized. The designs provided in the present disclosure are merely on an exemplary basis. Moreover, other similar designs may be utilized without deviating from the scope and spirit of the disclosure.

### INDUSTRIAL APPLICABILITY

Snap rings 134 are used to hold the injector 102 from falling apart against large spring assembly load. The snap ring 134 is positioned within the groove 132 provided on the injector body 110. The injector body 110 may be housed within the tappet 104. Due to lack of space and accessibility issues in a location where the snap ring 134 and injector 102 reside within the tappet 104, the installation of the snap ring 134 onto the injector body 110 and also the removal of the snap ring 134 from the injector body 110 is difficult.

Commercially available tools are known for the installation of the snap ring 134 onto the injector body 110. However, these tools cannot be utilized for the removal of the snap ring 134. The present disclosure relates to the tool 200 for easy installation of the snap ring 134 onto the injector body 110 as well as for the removal of the snap ring 134 from the injector body 110, as per the application. In one embodiment, the tool 200 may facilitate in the installation and removal of the snap ring 134 without damaging the snap ring 134. Moreover, the tool 200 may be used in various types of injectors 102, for example, MEUIC injectors.

FIG. 18 depicts the process for installation and removal of the snap ring 134 using the tools 200 shown in FIGS. 2 to 4. Firstly the tappet 104 may be compressed by any method known in the art. Secondly, the thrust plate and the plunger may be removed from the system 100, as shown FIG. 1. A person of ordinary skill in the art will appreciate that in case of performing the removal operation of the snap ring 134 from the injector body 110, the compression of the tappet 104 may cause the snap ring 134 to disengage from the groove 132 of the injector body 110.

When performing the removal operation of the snap ring 134 from the injector body 110, the tool 200 may be inserted into the tappet bore 122 as shown in the FIGS. 13 to 15. In one embodiment, the plurality of members 206 may be inserted into the slots 136 provided on the injector body 110. At step 1802, the snap ring 134 having the first diameter may be arranged in contact with the plurality of members 206 of the tool 200. The snap ring 134 may be in the free state or the normal working state at this instant. It should be noted that when installed on the injector body 110 the snap ring may be in the normal working state. Also, the plurality of members 206 of the tool 200 may be said to be in the free state, wherein the members 206 may be substantially vertical relative to the base 204 of the tool 200.

FIG. 16 depicts the cross-sectional view of the system 100 along the plane AA in case the removal operation is being performed. Moreover, the arranging of the snap ring 134 in contact with the tool 200, in case the installation operation is being performed, is illustrated in FIG. 11. Thereafter, in one embodiment, the handle 202 of the tool 200 may be moved in the downward direction, causing the plurality of members 206 to move in the substantially lateral direction at step 1804. As described earlier, different structural designs and connections between the handle 202 and the plurality of members 206 are shown in FIGS. 2 to 4.

In one embodiment, the movement of the handle 202 may result in the plurality of members 204 to pivot about the upper pin (see FIG. 2). In another embodiment, as shown in FIG. 3, movement of the handle 202 may cause the roller 302 to rotate in contact with the handle 202, causing the lateral movement of the plurality of members 206. In yet another embodiment, the lateral movement of the plurality of members 206 may be caused by the engagement of the gear-like structures 1002 in the corresponding grooves 602 of the handle 202, as shown in FIG. 4.

A person of ordinary skill in the art will appreciate that the driving mechanisms illustrated in FIGS. 2 to 4 are on an exemplary basis and other similar driving mechanisms may also be used without deviating from the scope of the present disclosure. The plurality of members 206 may be said to be in the expanded state at step 1804, wherein the plurality of members 206 may be substantially inclined with respect to the base 204 of the tool 200.

At step 1806, the diameter of the snap ring 134 may be changed from the first diameter to the second diameter based on the movement of the plurality members 206. In one embodiment, the second diameter may be greater than the first diameter. At this instant, the snap ring 134 may be said to be in the expanded state.

Further, at step 1808, any one of the installation operation of the snap ring 134 onto the injector body 110 or the removal operation of the snap ring 134 from the injector body 110 may be performed. The installation or removal operation may be preformed based on the changed diameter of the snap ring 134. A person of ordinary skill in the art will appreciate that in case the installation operation is being performed, the plurality of members 206 may be slid out of the tappet bore 122. It should be understood that elasticity property of the snap ring 134 may cause the snap ring 134 to be held in position within the groove 132 of the injector body 110. Hence, the plurality of members 206 may return to the free state, while the snap ring 134 may be installed on the injector body 110 in the normal working state.

On the other hand, during the removal operation, the snap ring 134 along with the plurality of members 206 may be drawn out of the tappet bore 122. In this case, both the plurality of members 206 and the snap ring 134 may return to the free state. It should be noted that the tool 200 may be used for effectively installing or removing the snap ring 134 relative to the injector body 110 even with limited access space provided within the system 100.

A person of ordinary skill in the art will appreciate that the structural designs and driving mechanisms depicted in the tools 200 shown in FIGS. 2 to 4 are merely on an exemplary basis. Other structural connections and driving mechanisms for laterally moving the plurality of members in order to change the diameter of the snap ring 134 may be utilized. Such designs also lie within the scope of this disclosure without any limitation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A tool comprising:
a handle;
a base attached to the handle; and
a plurality of members affixed to the base at one end, each of the plurality of members capable of movement in a substantially lateral direction, the plurality of members configured to change a diameter of a snap ring from a first diameter to a second diameter based on the movement.

2. The tool of claim 1, wherein the plurality of members are affixed to the base in a circular arrangement.

3. The tool of claim 1, wherein the handle is capable of movement in a substantially vertical direction, the movement configured to change a state of the plurality of members from a free state to an expanded state.

4. The tool of claim 3, wherein the plurality of members are substantially vertical with respect to the base in the free state.

5. The tool of claim 3, wherein the plurality of members are substantially inclined with respect to the base in the expanded state.

6. The tool of claim 1, wherein the second diameter is greater than the first diameter.

7. The tool of claim 1, wherein the plurality of members are made of metal.

8. The tool of claim 1, wherein at least one of the handle and the base is made of a polymer.

9. A method comprising:
arranging a snap ring having a first diameter in contact with a plurality of members of a tool;
moving the plurality of members in a substantially lateral direction;
changing the first diameter of the snap ring to a second diameter based on the movement of the plurality of members; and
performing any one of an installation operation of the snap ring onto an injector body or a removal operation of the snap ring from the injector body based, at least in part, on the changed diameter of the snap ring.

10. The method of claim 9 further including moving a handle of the tool in a substantially vertical direction, the movement configured to change a state of the plurality of members from a free state to an expanded state.

11. The method of claim 10, wherein the plurality of members are substantially vertical with respect to a base of the tool in the free state.

12. The method of claim 10, wherein the plurality of members are substantially inclined with respect to a base of the tool in the expanded state.

13. The method of claim 9, wherein the second diameter is greater than the first diameter.

14. A system comprising:
a snap ring;
a tappet;
an injector body having at least one groove configured to house the snap ring; and
a tool placed within the tappet, the tool including:
a handle;
a base ring attached to the handle; and
a plurality of members affixed to the base at one end, the members capable of movement in a substantially lateral direction, the plurality of members configured to change a diameter of a snap ring from a first diameter to a second diameter based on the movement.

15. The system of claim 14 further including a plurality of slots on the injector body, each of the plurality of slots configured to receive each of the corresponding plurality of members.

16. The system of claim 14, wherein the handle is capable of movement in a substantially vertical direction, the movement configured to change a state of the plurality of members from a free state to an expanded state.

17. The system of claim 14, wherein the plurality of members are substantially vertical with respect to the base in the free state.

18. The system of claim 14, wherein the plurality of members are substantially inclined with respect to the base in the expanded state.

19. The system of claim 14, wherein the second diameter is greater than the first diameter.
